(19) United States
(12) Patent Application Publication
(10) Pub. No.: US 2015/0233408 A1
(43) Pub. Date: Aug. 20, 2015

(54) SELF-REAMING SELF-TAPPING FASTENER

(71) Applicant: ROM Acquisition Corporation, Belton, MO (US)

(72) Inventors: John L. Kichline, JR., Pen Argyl, PA (US); Timothy D. Robertson, Easton, PA (US)

(73) Assignee: ROM Acquisition Corporation, Belton, MO (US)

(21) Appl. No.: 14/185,228

(22) Filed: Feb. 20, 2014

(51) Int. Cl. F16B 25/10

(52) U.S. Cl. CPC F16B 25/103

(57) ABSTRACT

A fastener comprises a driver head, an elongated shank having an unthreaded section coupled to the driver head and a threaded section terminating in a blunt end thereof, and at least two elongated flutes formed in the elongated shank extending over the threaded section and at least a portion of the unthreaded section. The elongated flutes are substantially triangular in cross-section with a vertex and two asymmetrical legs, one leg forming a cutting element adapted for reaming and cutting a thread in an opening having a diameter less than a major thread diameter of the threaded section.

### FIELD

The present disclosure relates to a fastener, and more particularly to a self-reaming and self-tapping fastener.

### BACKGROUND

Threaded fasteners such as screws and bolts are commonly used to secure two components together. Because threaded fasteners can be removed to permit disassembly, they are sometimes preferred over permanent methods of fastening, such as welding or riveting. In certain applications, the fastener is required to meet a specified load requirement to avoid failure. Therefore, fasteners are designed and rated for certain loads.

Threaded fasteners may fail due to overstress or fatigue. Overstress occurs when the load on the fastener, in tension, shear, or bending, is too high. A tensile load is generally a combination of preload (tension induced during installation) and in-service load (tension experienced after installation). A tensile load exerts a force along the longitudinal axis of the fastener in directions that attempt to pull the joint assembly apart. A shear load is a force perpendicular to the longitudinal axis of the fastener, and bending stresses arise from bearing and mating surfaces that are not perpendicular to the fastener's longitudinal axis.

Fatigue is a major cause of failure, where the fastener is subjected to a small preload and an alternating or cyclic load during service. These cyclic stresses can cause the fasteners to fail at loads less than their rated tensile strength under near-static conditions.

### SUMMARY

The present disclosure is directed to embodiments of a self-reaming and self-tapping fastener.

A fastener comprises a driver head, an elongated shank having an unthreaded section coupled to the driver head and a threaded section terminating in a blunt end thereof, and at least two elongated flutes formed in the elongated shank extending over the threaded section and at least a portion of the unthreaded section. The elongated flutes are substantially triangular in cross-section with a vertex and two asymmetrical legs, one leg forming a cutting element adapted for reaming and cutting a thread in an opening having a diameter less than a major thread diameter of the threaded section.

A fastener comprises a head portion, an elongated shank portion having a longitudinal axis and coupled to the head portion, the elongated shank having an un-threaded section and a threaded section terminating in an end thereof, and at least one elongated flute formed in the elongated shank portion along the same longitudinal axis and extending over the threaded section and at least a portion of the unthreaded section.

A fastener comprises an elongated shank having an unthreaded section terminating in a first end and a threaded section terminating in a second end thereof, the threaded section defining a major thread diameter and a minor thread diameter, at least two elongated flutes formed in the elongated shank extending from the second end of the elongated shank and over at least a portion of the unthreaded section, and the at least two elongated flutes defining an elongated cutting edge and an elongated cutting face adapted to cut a thread in an opening having a diameter approximately equal to the minor thread diameter as the fastener is rotated inside the opening, the at least two elongated flutes further adapted to pass materials cut from the opening toward the first end of the elongated shank.

### BRIEF DESCRIPTION OF THE DRAWINGS

FIG. 1 is a plan view of a first exemplary embodiment of a self-reaming self-tapping fastener according to the teachings of the present disclosure;

FIG. 2 is a second plan view of a first exemplary embodiment of a self-reaming self-tapping fastener according to the teachings of the present disclosure;

FIG. 3 is a cross-sectional view taken generally along line 3-3 of FIG. 2, and a detailed view thereof;

FIG. 4 is an end view of a first exemplary embodiment of a self-reaming self-tapping fastener according to the teachings of the present disclosure; and

FIG. 5 is a plan view of a second exemplary embodiment of a self-reaming self-tapping fastener according to the teachings of the present disclosure.

### DETAILED DESCRIPTION

It is desirable to provide a partially-threaded fastener that is self-reaming and self-tapping with improved load-bearing characteristics, including fatigue due to bending stresses.

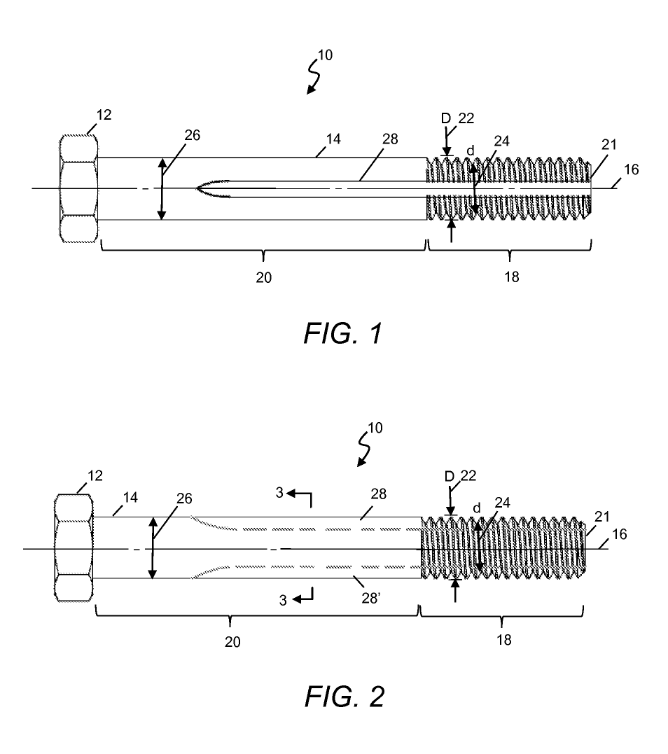

FIG. 1 is a plan view of a first exemplary embodiment of a self-reaming self-tapping fastener 10 according to the teachings of the present disclosure. Reference is also made to FIG. 2 for another side view of the fastener 10. The fastener 10 includes a driver head portion 12 and a shank portion 14 defined along a longitudinal axis 16. The head portion 12 may be hexagonal in shape, but may have other shapes such as round, flat, square, pan, flanged, binding, oval, fillister, carriage, plow, truss, clevis, etc., and can be made to accommodate various types of drivers. The shank portion 14 is partially threaded, with a threaded section 18 and an un-threaded section 20. The threaded section 18 of the shank portion 14 terminates in a blunt end 21. The end 21 may also be a pointed tip adapted for drilling and creating an opening. The threaded section 18 of the shank portion 14 is defined by a major thread diameter D, referenced by numeral 22, and a minor thread diameter d, referenced by numeral 24. The pitch of the thread may be designed according to the intended application, such as 18 threads per inch. The diameter 26 of the unthreaded shank portion 20 may be the same or less than the major thread diameter D 22. For maximum performance, the fastener should be manufactured using methods and materials that produce an appropriate balance of strength and ductility for the design loads.

Further defined in the shank portion 14 of the fastener 10 is at least one flute 28.

Preferably, two flutes 28 and 28′ are formed on opposite sides of the shank portion 14, but the present disclosure also contemplates more than two flutes. The flutes 28 and 28′ are preferably elongated channels or slots formed in the shank portion 14 extending from its blunt end 21 toward the head portion 12 along most of the length of the shank portion 14, but does not extend the entire length of the shank portion 14. As shown in FIGS. 1 and 2, the flutes 28 and 28′ preferably have a tapered depth and width near the end in the un-threaded portion 20 of the shank. The flute 28 defines an elongated cutting edge and an elongated cutting face adapted to perform the self-reaming and self-tapping functionalities of the fastener, described in more detail below.

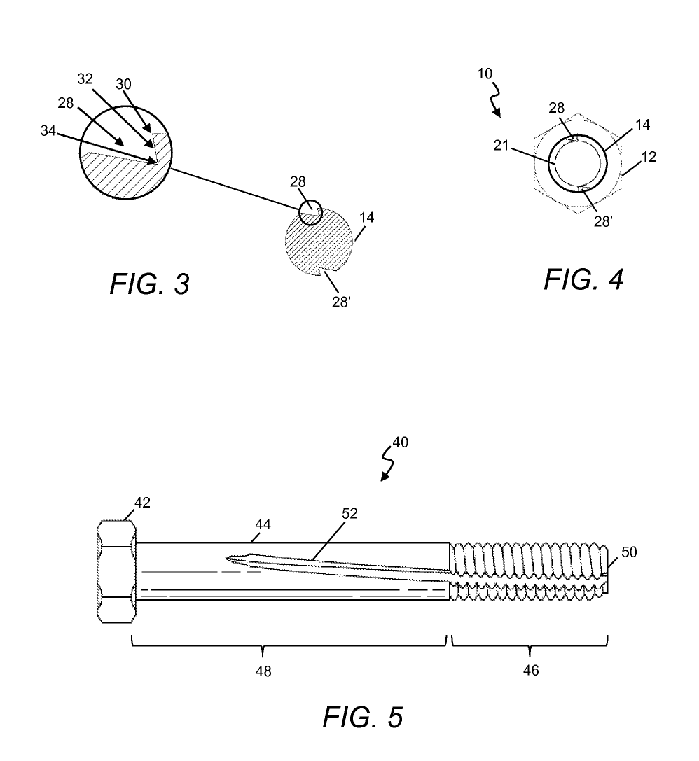

FIG. 3 is a cross-sectional view taken generally along line 3-3 of FIG. 2, and a detailed view thereof. FIG. 3 shows details of the flutes 28 and 28′. As shown in FIG. 3, the cross-section of the flute 28 is generally triangular, defining a cutting edge 30 and a cutting face 32. The cross-section of the flute 28 further terminates in a vertex 34, where the two legs of the triangle are generally asymmetrical. The cutting edge 30 and face 32 are generally formed on the shorter leg of the triangle that faces the direction of rotation as the fastener 10 is rotated clockwise or tightened. As the fastener 10 is turned clockwise to tighten it, the cutting edges 30 and cutting faces 32 of the flutes 28 and 28′ create the thread and counterbore in the material.

In operation, the fastener 10 is inserted into an opening preferably having a diameter approximately the same or close to the minor thread diameter d. The opening may be formed of aligned openings in two or more components that are to be secured together. As the fastener 10 is rotated clockwise in the opening, material is shaved off or cut by the cutting edges 30 and cutting faces 32 of the flutes 28 and 28′. Additionally, the removed material is transferred out of the opening by moving up in the flutes 28 and 28′ toward the drive head portion 12. Although the cross-section of the flutes 28 and 28′ are preferably asymmetrical as shown, other shapes such as an isosceles triangle with equal legs are also contemplated.

It has been shown in tests that under combined loading conditions (bending and tensile loads), the highest stress experienced in conventional self-threading fasteners in a specific application is in the threaded section of the shank. In the fastener described in the present disclosure, the maximum stress is shifted to the unthreaded section of the shank, which is adapted to withstand higher loads.

FIG. 4 is an end view of a first exemplary embodiment of a self-reaming self-tapping fastener 10 according to the teachings of the present disclosure. From this view, the flutes 28 and 28′ are clearly visible. The flutes 28 and 28′ define the cutting edges and cutting faces that enable the fastener 10 to be self-reaming and self-tapping. The flutes 28 and 28′ further function as channels for passing the removed materials up and out of the openings.

FIG. 5 is a plan view of a second exemplary embodiment of a self-reaming self-tapping fastener 40 according to the teachings of the present disclosure. The fastener 40 includes a driver head portion 42 and a shank portion 44. The head portion 42 may be hexagonal in shape, but may have other shapes such as round, flat, square, pan, flanged, binding, oval, fillister, carriage, plow, truss, clevis, etc., and can be made to accommodate various types of drivers. The shank portion 44 is partially threaded, with a threaded section 46 and an un-threaded section 48. The threaded section 46 of the shank portion 44 terminates in a blunt end 50. The end 50 may also be a pointed tip adapted for drilling and creating an opening. The threaded section 46 of the shank portion 44 is defined by a major thread diameter D, and a minor thread diameter d. The pitch of the thread may be designed according to the intended application, such as 18 threads per inch. The diameter of the unthreaded shank portion 48 may be the same or less than the major thread diameter D. For maximum load rating, the fastener should be manufactured using methods and materials that produce the highest load rating.

Further defined in the shank portion 44 of the fastener 40 is at least one helical flute 52. Preferably, two helical flutes are formed on opposite sides of the shank portion 44, but the present disclosure also contemplates more than two flutes. The flutes 52 are preferably elongated channels or slots formed in the shank portion 44 extending from its blunt end 50 toward the head portion 42 along most of the length of the shank portion 44, but does not extend the entire length of the shank portion. The helical flutes 52 preferably have a tapered depth and width near the end in the un-threaded portion 48 of the shank. Similar to the straight flute 28, the helical flute 52 also defines an elongated cutting edge and an elongated cutting face adapted to perform the self-reaming and self-tapping functionalities of the fastener, described in detail above. The rate of rotation or pitch of the helical flute can be varied according to desired applications.

The features of the present invention which are believed to be novel are set forth below with particularity in the appended claims. However, modifications, variations, and changes to the exemplary embodiments described above will be apparent to those skilled in the art, and the self-reaming self-tapping fastener described herein thus encompasses such modifications, variations, and changes and are not limited to the specific embodiments described herein.

1. A fastener comprising:
a driver head;
an elongated shank having an unthreaded section coupled to the driver head and a threaded section terminating in a blunt end thereof;
at least two elongated flutes formed in the elongated shank extending over the threaded section and at least a portion of the unthreaded section;
wherein the elongated flutes are substantially triangular in cross-section with a vertex and two asymmetrical legs, one leg forming a cutting element adapted for reaming and cutting a thread in an opening having a diameter less than a major thread diameter of the threaded section.

2. The fastener of claim 1, wherein the at least two elongated flutes are straight and defined on opposite sides of the elongated shank.

3. The fastener of claim 1, wherein the at least two elongated flutes are helical and defined on opposite sides of the elongated shank.

4. The fastener of claim 1, wherein the driver head has a shape selected from a group consisting of hexagon, round, flat, square, pan, flanged, binding, oval, fillister, carriage, plow, truss, and clevis shapes.

5. The fastener of claim 1, wherein the elongated flutes comprise a first end terminating at the blunt end of the elongated shank, and a second end terminating in the unthreaded section, where the second end having tapered dimensions.

6. A fastener comprising:
a head portion;
an elongated shank portion having a longitudinal axis and coupled to the head portion, the elongated shank having an un-threaded section and a threaded section terminating in an end thereof; and
at least one elongated flute formed in the elongated shank portion along the same longitudinal axis and extending over the threaded section and at least a portion of the unthreaded section.

7. The fastener of claim 6 comprising at least two elongated flutes being substantially triangular in cross-section forming a cutting element adapted for reaming and cutting a thread.

8. The fastener of claim 7, wherein the at least two elongated flutes have a substantially triangular cross-section with a vertex and two asymmetrical legs.

9. The fastener of claim 6, wherein the at least two elongated flutes are straight and defined on opposite sides of the elongated shank.

10. The fastener of claim 6, wherein the at least two elongated flutes are helical and defined on opposite sides of the elongated shank.

11. The fastener of claim 6, wherein the driver head has a shape selected from a group consisting of hexagon, round, flat, square, pan, flanged, binding, oval, fillister, carriage, plow, truss, and clevis shapes.

12. The fastener of claim 6, wherein the elongated flutes comprise a first end terminating at the blunt end of the elongated shank, and a second end terminating in the unthreaded section, where the second end having tapered dimensions.

13. A fastener comprising:
an elongated shank having an unthreaded section terminating in a first end and a threaded section terminating in a second end thereof;
the threaded section defining a major thread diameter and a minor thread diameter;
at least two elongated flutes formed in the elongated shank extending from the second end of the elongated shank and over at least a portion of the unthreaded section; and
the at least two elongated flutes defining an elongated cutting edge and an elongated cutting face adapted to cut a thread in an opening having a diameter approximately equal to the minor thread diameter as the fastener is rotated inside the opening, the at least two elongated flutes further adapted to pass materials cut from the opening toward the first end of the elongated shank.

14. The fastener of claim 13, wherein the first end of the elongated shank comprises a driver head.

15. The fastener of claim 13, wherein the at least two elongated flutes are substantially triangular in cross-section forming a cutting edge and cutting face adapted for reaming and cutting a thread.

16. The fastener of claim 13, wherein the at least two elongated flutes are straight and defined on opposite sides of the elongated shank.

17. The fastener of claim 13, wherein the at least two elongated flutes are helical and defined on opposite sides of the elongated shank.

18. The fastener of claim 13, wherein the at least two elongated flutes comprise a first end terminating at a blunt second end of the elongated shank, and a second end terminating in the unthreaded section, where the second end having tapered dimensions.
